(19) United States
(12) Patent Application Publication
(10) Pub. No.: US 2026/0106166 A1
(43) Pub. Date: Apr. 16, 2026

(54) CURRENT COLLECTOR AND BATTERY

(71) Applicant: TOYOTA JIDOSHA KABUSHIKI KAISHA, Toyota-shi (JP)

(72) Inventors: Masaki FURUKAWA, Toyota-shi (JP); Tetsuya Mimura, Chiryu-shi (JP); Atsushi Sugihara, Toyota-shi (JP); Satoshi Moriyama, Nagoya-shi (JP); Masayoshi Haga, Nagoya-shi (JP); Keita Yamashita, Nagoya-shi (JP); Ryuto Sakamoto, Okazaki-shi (JP); Hideyuki Nagai, Nagoya-shi (JP)

(73) Assignee: TOYOTA JIDOSHA KABUSHIKI KAISHA, Toyota-shi (JP)

(21) Appl. No.: 19/247,227

(22) Filed: Jun. 24, 2025

(30) Foreign Application Priority Data
Oct. 16, 2024 (JP) 2024-180985

(51) Int. Cl. H01M 4/66; H01M 50/536

(52) U.S. Cl. CPC H01M 4/667; H01M 4/661; H01M 50/536

(57) ABSTRACT

A current collector includes a support layer, an electrically conductive layer, and an intermediate electrically conductive layer. The support layer is made of a resin composition having an electrical insulation property. The electrically conductive layer is made of metal containing aluminum. The intermediate electrically conductive layer is made of metal containing magnesium. The electrically conductive layer is joined to the support layer via the intermediate electrically conductive layer.

### CROSS-REFERENCE TO RELATED APPLICATION

This application claims priority to Japanese Patent Application No. 2024-180985 filed on Oct. 16, 2024. The disclosure of the above-identified application, including the specification, drawings, and claims, is incorporated by reference herein in its entirety.

### BACKGROUND

### 1. Technical Field

The present disclosure relates to a current collector and a battery. 2. Description of Related Art

In Japanese Unexamined Patent Application Publication (Translation of PCT Application) No. 2024-510696 (JP 2024-510696 A), a related-art electrode plate is disclosed. The electrode plate includes a current collector, an active material layer, and an electrical connection member. The current collector includes a support layer and an electrically conductive layer. The support layer is a polyethylene film, a polypropylene film, a polyvinylidene chloride film, or a multilayer composite film thereof. The electrically conductive layer is installed on one surface of the support layer. When the current collector is a positive electrode current collector, aluminum is normally used as the material of the electrically conductive layer. When the current collector is a negative electrode current collector, copper is normally used as the material of the electrically conductive layer.

### SUMMARY

For example, when an electrically conductive layer containing aluminum is provided on a support layer by a vapor deposition method or a sputtering method in order to cause the electrically conductive layer to be thin, the adhesive force between the electrically conductive layer and the support layer is relatively weak. As above, there has been room for further improvement in terms of inhibiting peeling between the electrically conductive layer and the support layer.

The present disclosure has been made in view of the problem described above, and an object thereof is to provide a current collector and a battery capable of inhibiting an electrically conductive layer from being peeled off from a support layer.

A current collector according to an aspect of the present disclosure includes a support layer, an electrically conductive layer, and an intermediate electrically conductive layer. The support layer is made of a resin composition having an electrical insulation property. The electrically conductive layer is made of metal containing aluminum. The intermediate electrically conductive layer is made of metal containing magnesium. The electrically conductive layer is joined to the support layer via the intermediate electrically conductive layer.

A battery according to an aspect of the present disclosure includes an electrode body and an external terminal. The electrode body includes a first electrode, a second electrode, and a separator. The first electrode includes a current collector and an active material layer. The current collector includes a support layer, an electrically conductive layer, and an intermediate electrically conductive layer. The support layer is made of a resin composition having an electrical insulation property. The electrically conductive layer is made of metal containing aluminum. The intermediate electrically conductive layer is made of metal containing magnesium. The electrically conductive layer is joined to the support layer via the intermediate electrically conductive layer. The active material layer is laminated on the electrically conductive layer. The separator is laminated on the active material layer. The second electrode is laminated on the active material layer via the separator. The external terminal is electrically connected to the electrically conductive layer.

With the present disclosure, it is possible to inhibit the electrically conductive layer from being peeled off from the support layer.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view showing a battery according to one embodiment;

FIG. 2 is a sectional view of an electrode body in FIG. 1 seen in the direction of arrows of line II-II;

FIG. 3 is a development view of a first electrode in one embodiment; and

FIG. 4 is a partial sectional view of the first electrode in FIG. 3 seen in the direction of arrows of line IV-IV.

### DETAILED DESCRIPTION OF EMBODIMENTS

A current collector and a battery according to one embodiment of the present disclosure are described below with reference to the drawings. The same or equivalent parts in the drawings are denoted by the same reference characters, and description thereof is not repeated.

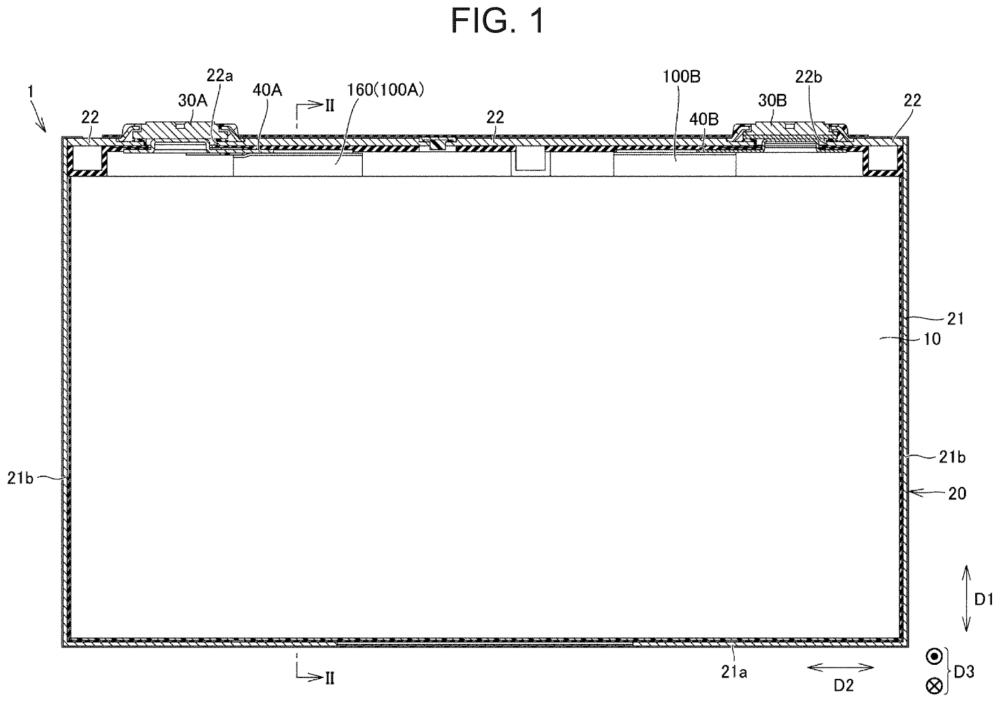

FIG. 1 is a sectional view showing the battery according to one embodiment. A battery 1 shown in FIG. 1 is a so-called square battery. The battery 1 may be a secondary battery configured in a manner in which charging and discharging are possible such as a lithium-ion battery and a nickel hydride battery. The battery 1 may be used as a cell included in an electricity storage module mounted on an electrified vehicle, for example.

As shown in FIG. 1, the battery 1 according to one embodiment of the present disclosure includes an electrode body 10, a case 20, a first external terminal 30A, a second external terminal 30B, a first coupling member 40A, and a second coupling member 40B. First, configurations other than the electrode body 10 out of the battery 1 are described.

The case 20 has electrical conductivity. The part of the case 20 having electrical conductivity is made of metal such as aluminum, for example. The case 20 accommodates the electrode body 10. The case 20 also accommodates an electrolytic solution (not shown).

The case 20 includes a case main body 21 and a lid 22. The case main body 21 includes a bottom wall 21a and peripheral walls 21b upstanding from the bottom wall 21a.

The lid 22 is joined to the peripheral walls 21b by welding and the like so as to close an opening of the peripheral walls 21b. A first coupling hole 22a and a second coupling hole 22b are formed in the lid 22.

The first external terminal 30A and the second external terminal 30B are provided in the battery 1 so as to be exposed to the outside. The first coupling member 40A and the second coupling member 40B have electrical conductivity. The first coupling member 40A and the second coupling member 40B have at least a part thereof disposed on the inside of the case 20.

The first external terminal 30A or the first coupling member 40A is inserted through the first coupling hole 22a. The first external terminal 30A is electrically connected to the first coupling member 40A. Specifically, the first external terminal 30A and the first coupling member 40A are joined to each other. The first coupling member 40A is joined to the electrode body 10. As a result, the first external terminal 30A is electrically connected to the electrode body 10.

The second external terminal 30B or the second coupling member 40B is inserted through the second coupling hole 22b. The second external terminal 30B is electrically connected to the second coupling member 40B. Specifically, the second external terminal 30B and the second coupling member 40B are joined to each other. The second coupling member 40B is joined to the electrode body 10. As a result, the second external terminal 30B is electrically connected to the electrode body 10.

In the present embodiment, the first external terminal 30A is a positive electrode terminal, and the second external terminal 30B is a negative electrode terminal. The first external terminal 30A and the second external terminal 30B are lined up in a second direction D2. The second direction D2 is a direction orthogonal to a first direction D1.

Next, the electrode body 10 is described. The battery 1 according to the present embodiment includes a plurality of the electrode bodies 10. The battery 1 typically includes two electrode bodies 10. The electrode bodies 10 are lined up in a third direction D3. The third direction D3 is a direction orthogonal to both the first direction D1 and the second direction D2.

One electrode body 10 out of the electrode bodies 10 is described below. Each of the electrode bodies 10 may include a configuration described below.

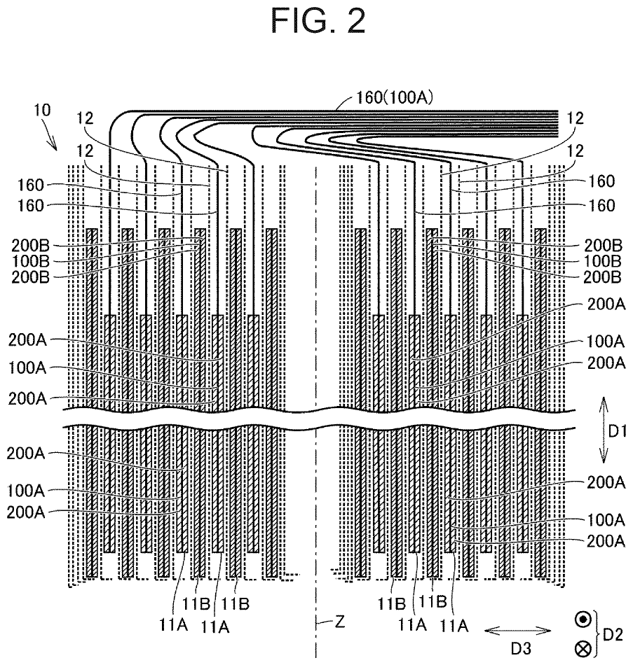

FIG. 2 is a sectional view of the electrode body in FIG. 1 seen in the direction of arrows of line II-II. As shown in FIG. 1 and FIG. 2, the electrode body 10 includes a first electrode 11A, a second electrode 11B, and separators 12. In the electrode body 10, the first electrode 11A, the second electrode 11B, and the separators 12 are wound around so as to surround the periphery of a winding axial line Z. As above, in the present embodiment, the electrode body 10 is a so-called wound electrode body. However, the electrode body 10 may be a laminated electrode body in which the first electrodes 11A, the second electrodes 11B, and the separators 12 are laminated in one direction (for example, the third direction D3). In FIG. 2, the separators 12 are schematically shown by broken lines.

The first electrode 11A and the second electrode 11B have sheet-like external forms. The electrode body 10 is configured by an electrode plate group in which the first electrode 11A and the second electrode 11B are wound around via one or more separators 12. In the present embodiment, the first electrode 11A is a positive electrode, and the second electrode 11B is a negative electrode. However, the first electrode 11A may be a negative electrode, and the second electrode 11B may be a positive electrode.

The separators 12 are provided between the first electrode 11A and the second electrode 11B. The separators 12 separate the first electrode 11A and the second electrode 11B from each other while enabling movement of ions between the first electrode 11A and the second electrode 11B. The ions are lithium ions, for example. The separators 12 have an electrical insulation property.

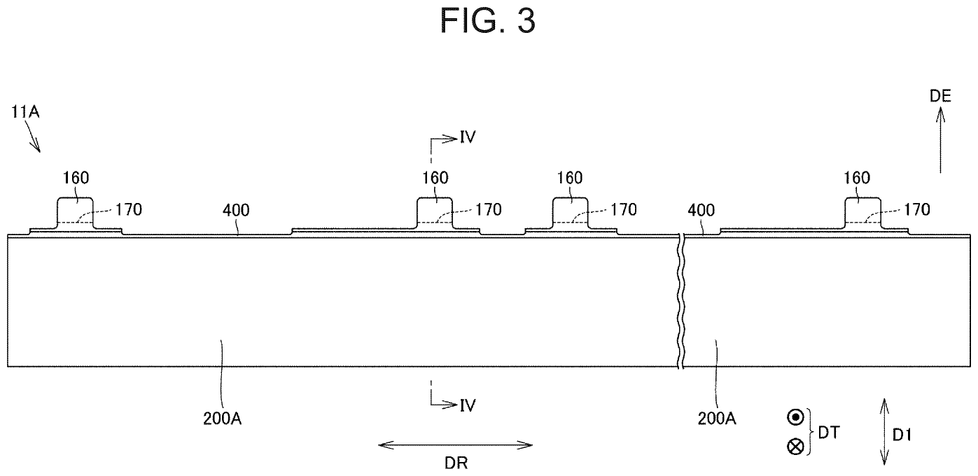

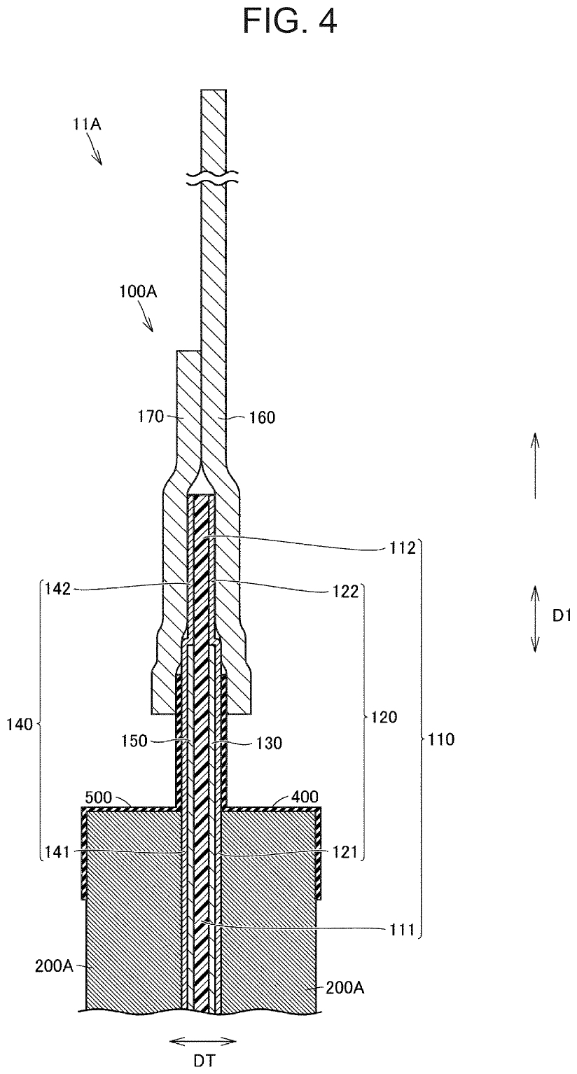

FIG. 3 is a development view of the first electrode in one embodiment. In other words, the state before the winding of the first electrode 11A is shown in FIG. 3. FIG. 4 is a partial sectional view of the first electrode in FIG. 3 seen in the direction of arrows of line IV-IV.

As shown in FIG. 2 to FIG. 4, the first electrode 11A includes a first current collector 100A, a pair of first active material layers 200A, a first protection portion 400, and a second protection portion 500.

As shown in FIG. 4, the first current collector 100A includes a support layer 110, a first electrically conductive layer 120, a first intermediate electrically conductive layer 130, a second electrically conductive layer 140, a second intermediate electrically conductive layer 150, a plurality of tab portions 160, and a plurality of electrical conduction assisting portions 170.

The support layer 110 is made of a resin composition having an electrical insulation property. Therefore, the first current collector 100A is a composite current collector including electrically conductive members and electrical insulation members. As a result, as compared to a case in which the first current collector 100A is made of metal as a whole, the first current collector 100A is lighter in weight, and the safety of the battery 1 as a whole is increased.

The support layer 110 is made of a material having a higher rigidity than the separators 12. The support layer 110 is made of a resin composition containing polyamide-based resin, polyester-based resin, or polyolefin-based resin, for example. In order to increase rigidity, it is preferred that the support layer 110 be made of a resin composition containing polyester-based resin. It is further preferred that the support layer 110 be substantially made of polyester-based resin. The polyester-based resin may be polyethylene terephthalate (PET), for example. As a result, the rigidity of the first current collector 100A can be increased while the electrical insulation property of the support layer 110 can be maintained. Therefore, the support layer 110 can be caused to become relatively thin.

A thickness direction DT of the support layer 110 is substantially orthogonal to the first direction D1. In other words, the support layer 110 extends in a direction substantially orthogonal to the first direction D1.

The thickness of the entire support layer 110 is preferably 20 μm or less, more preferably 15 μm or less, and further preferably 10 μm or less, for example, in order to cause the entire thickness of the electrode body 10 to be thinner. The thickness of the entire support layer 110 is not particularly limited as long as the entire support layer 110 has a desired rigidity. The thickness of the support layer 110 only needs to be 2 μm or more, for example.

The support layer 110 includes a main body portion 111 and an extending portion 112. The main body portion 111 is laminated with respect to the first intermediate electrically conductive layer 130 and the second intermediate electrically conductive layer 150 between the first intermediate electrically conductive layer 130 and the second intermediate electrically conductive layer 150. The extending portion 112 extends from the main body portion 111 in a direction orthogonal to the thickness direction DT. The extending portion 112 spaces the first intermediate electrically conductive layer 130 and the second intermediate electrically conductive layer 150 from each other, and the first intermediate electrically conductive layer 130 and the second intermediate electrically conductive layer 150 are not joined to each other. The extending portion 112 joins a part of the first electrically conductive layer 120 and a part of the second electrically conductive layer 140 to each other.

The first electrically conductive layer 120 is made of metal containing aluminum. As a result, the first current collector 100A including the first electrically conductive layer 120 may be suitably used as a positive electrode current collector. It is possible to configure the first electrically conductive layer 120 by substantially only aluminum. The first current collector 100A may be a negative electrode current collector.

The first electrically conductive layer 120 is positioned on one side of the support layer 110 in the thickness direction DT. The first electrically conductive layer 120 is joined to the support layer 110 via the first intermediate electrically conductive layer 130. The first electrically conductive layer 120 includes a first electrically conductive main body portion 121 and a first electrically conductive extending portion 122. The first electrically conductive main body portion 121 is joined to the first intermediate electrically conductive layer 130. The first electrically conductive extending portion 122 extends from the first electrically conductive main body portion 121. The first electrically conductive extending portion 122 is joined to the extending portion 112. The first electrically conductive extending portion 122 is not joined to the first intermediate electrically conductive layer 130.

The first intermediate electrically conductive layer 130 is made of metal containing magnesium. As a result, when the support layer 110 is made of a resin composition containing polyester-based resin (in particular, PET), the magnesium of the first intermediate electrically conductive layer 130 and oxygen atoms contained in the polyester-based resin of the support layer 110 are easily bonded to each other. As a result, the first intermediate electrically conductive layer 130 and the support layer 110 are joined to each other in an even firmer manner. Therefore, the first electrically conductive layer 120 connected to the first intermediate electrically conductive layer 130 is inhibited from being peeled off from the support layer 110 even more.

The first intermediate electrically conductive layer 130 may be an alloy containing metal different from magnesium. The alloy may contain at least one type or more selected from a group consisting of copper, nickel, tin, aluminum, zinc, iron, manganese, cobalt, and titanium.

The second electrically conductive layer 140 is positioned on the other side of the support layer 110 in the thickness direction DT. The second electrically conductive layer 140 is made of metal containing aluminum. It is possible to configure the second electrically conductive layer 140 by substantially only aluminum.

The second electrically conductive layer 140 is joined to the support layer 110 via the second intermediate electrically conductive layer 150. The second electrically conductive layer 140 includes a second electrically conductive main body portion 141 and a second electrically conductive extending portion 142. The second electrically conductive main body portion 141 is joined to the second intermediate electrically conductive layer 150. The second electrically conductive extending portion 142 extends from the second electrically conductive main body portion 141. The second electrically conductive extending portion 142 is joined to the extending portion 112. The second electrically conductive extending portion 142 is not joined to the second intermediate electrically conductive layer 150.

The second intermediate electrically conductive layer 150 is made of metal containing magnesium. As a result, when the support layer 110 is made of a resin composition containing polyester-based resin (in particular, PET), the magnesium of the second intermediate electrically conductive layer 150 and oxygen atoms contained in the polyester-based resin of the support layer 110 are easily bonded to each other. As a result, the second intermediate electrically conductive layer 150 and the support layer 110 are joined to each other in an even firmer manner. Therefore, the second electrically conductive layer 140 connected to the second intermediate electrically conductive layer 150 is inhibited from being peeled off from the support layer 110 even more.

The second intermediate electrically conductive layer 150 may be an alloy containing metal different from magnesium. The alloy may contain at least one type or more selected from a group consisting of copper, nickel, tin, aluminum, zinc, iron, manganese, cobalt, and titanium.

The thickness of each of the first electrically conductive layer 120, the first intermediate electrically conductive layer 130, the second electrically conductive layer 140, and the second intermediate electrically conductive layer 150 is thinner than the thickness of the support layer 110. The thickness of each of the first intermediate electrically conductive layer 130, the second electrically conductive layer 140, and the second intermediate electrically conductive layer 150 is preferably 5 μm or less, more preferably 2 μm or less, and further preferably 1 μm or less, for example, in order to cause the entire thickness of the electrode body 10 to be thinner. The thickness of each of the first intermediate electrically conductive layer 130, the second electrically conductive layer 140, and the second intermediate electrically conductive layer 150 only needs to be 0.1 μm or more, for example, in order to inhibit the electrical resistance thereof from becoming excessively great. When each of the thickness of the first electrically conductive layer 120 and the thickness of the second electrically conductive layer 140 is 5 μm or less, it is difficult to directly weld the first electrically conductive layer 120 and the second electrically conductive layer 140 to each other or directly join the first electrically conductive layer 120 and the second electrically conductive layer 140 to each other by ultrasonic welding.

The method of forming each of the first electrically conductive layer 120, the first intermediate electrically conductive layer 130, the second electrically conductive layer 140, and the second intermediate electrically conductive layer 150 is not particularly limited. Those layers may be typically provided by a vapor deposition method or a sputtering method.

As shown in FIG. 3, the tab portions 160 are lined up in a winding direction DR of the electrode body 10. The electrical conduction assisting portions 170 are lined up in the winding direction DR of the electrode body 10. The tab portions 160 are spaced apart from each other. The electrical conduction assisting portions 170 are spaced apart from each other. The electrical conduction assisting portions 170 are lined up with the tab portions 160 so as to correspond to the tab portions 160 in a one-to-one manner in the thickness direction DT.

As shown in FIG. 2, the tab portions 160 are lined up in the third direction D3. The tab portions 160 are joined to each other by ultrasonic joining and the like. As shown in FIG. 1, the tab portions 160 are joined to the first coupling member 40A by ultrasonic joining and the like. As a result, the first external terminal 30A is electrically connected to the tab portions 160. Therefore, the first external terminal 30A is electrically connected to the first electrically conductive layer 120 and the second electrically conductive layer 140. The configuration included in each of the tab portions 160 and the configuration included in each of the electrical conduction assisting portions 170 are described below.

As shown in FIG. 4, each tab portion 160 is partially lined up with the first electrically conductive extending portion 122 and the first electrically conductive main body portion 121 in the thickness direction DT. The tab portion 160 extends on the first electrically conductive layer 120 substantially along the first direction D1. The tab portion 160 is joined to the first electrically conductive extending portion 122 by ultrasonic welding. The tab portion 160 is joined to a part of the first electrically conductive main body portion 121 by ultrasonic welding. The tab portion 160 extends so as to separate from the first electrically conductive layer 120. The extending direction DE of the tab portion 160 is substantially parallel to the first direction D1. The tab portion 160 may be directly joined to the first external terminal 30A.

Each electrical conduction assisting portion 170 is partially lined up with the second electrically conductive extending portion 142 and the second electrically conductive main body portion 141 in the thickness direction DT. The electrical conduction assisting portion 170 extends on the second electrically conductive layer 140 substantially along the first direction D1. The electrical conduction assisting portion 170 is joined to the second electrically conductive extending portion 142 by ultrasonic welding. The electrical conduction assisting portion 170 is joined to a part of the second electrically conductive main body portion 141 by ultrasonic welding. The electrical conduction assisting portion 170 extends so as to separate from the second electrically conductive layer 140. An end portion of the electrical conduction assisting portion 170 in the extending direction DE is joined to the tab portion 160 by ultrasonic joining.

The tab portion 160 and the electrical conduction assisting portion 170 are made of film-like members. The tab portion 160 and the electrical conduction assisting portion 170 are typically made of metal films containing aluminum, copper, or the like.

The thickness of each of the tab portion 160 and the electrical conduction assisting portion 170 is thicker than the thickness of each of the first electrically conductive layer 120, the first intermediate electrically conductive layer 130, the second electrically conductive layer 140, and the second intermediate electrically conductive layer 150. The thickness of each of the tab portion 160 and the electrical conduction assisting portion 170 is preferably 20 μm or less, more preferably 15 μm or less, and further preferably 10 μm or less, for example. Each thickness above is not particularly limited as long as the entire support layer 110 has a desired rigidity. Each thickness above only needs to be 2 μm or more, for example.

One of the first active material layers 200A is laminated on the first electrically conductive layer 120. Specifically, one of the first active material layers 200A is laminated on a part of the first electrically conductive main body portion 121. One of the first active material layers 200A is laminated on the first electrically conductive extending portion 122. In other words, the first active material layer 200A is not laminated on a connecting part between the first electrically conductive extending portion 122 and the first electrically conductive main body portion 121. As a result, a pressure applied to the first active material layer 200A when the first active material layer 200A is pressed against the first electrically conductive layer 120 by a press roll, for example, becomes relatively uniform. One of the first active material layers 200A is not laminated on an end portion of the first electrically conductive main body portion 121 in the extending direction DE thereof either.

The other of the first active material layers 200A is laminated on the second electrically conductive layer 140. Specifically, the other of the first active material layers 200A is laminated on a part of the second electrically conductive main body portion 141. The other of the first active material layers 200A is not laminated on the second electrically conductive extending portion 142. The other of the first active material layers 200A is not laminated on an end portion of the second electrically conductive main body portion 141 in the extending direction DE thereof either.

The first active material layers 200A are positive electrode active material layers but may be negative electrode active material layers. The first active material layers 200A space the tab portion 160 and the electrical conduction assisting portion 170 apart from each other. The separators 12 are laminated on the first active material layers 200A in a radial direction about the winding axial line Z.

The first protection portion 400 is made of ceramic having an electrical insulation property. The first protection portion 400 covers a part of the first active material layer 200A laminated on the first electrically conductive layer 120 in the extending direction DE thereof. The first protection portion 400 covers the entirety of a surface of the first electrically conductive layer 120 (first electrically conductive main body portion 121) between the first active material layer 200A and the tab portion 160. The first protection portion 400 is also partially disposed between the first electrically conductive layer 120 (first electrically conductive main body portion 121) and the tab portion 160 in the thickness direction DT.

The second protection portion 500 is made of ceramic having an electrical insulation property. The second protection portion 500 covers a part of the first active material layer 200A laminated on the second electrically conductive layer 140 in the extending direction DE thereof. The second protection portion 500 covers the entirety of a surface of the second electrically conductive layer 140 (second electrically conductive main body portion 141) between the first active material layer 200A and the electrical conduction assisting portion 170. The second protection portion 500 is partially disposed between the second electrically conductive layer 140 (second electrically conductive main body portion 141) and the electrical conduction assisting portion 170 in the thickness direction DT.

As shown in FIG. 2, the second electrode 11B is laminated on the first active material layers 200A via the separators 12 in the radial direction. In the present embodiment, the electrode body 10 includes a plurality of the separators 12, but the electrode body 10 may include one separator 12.

The second electrode 11B includes a second current collector 100B and second active material layers 200B. The second current collector 100B is pulled out to one side in the first direction D1 from a place between the second active material layers 200B. The second current collector 100B is joined to the second coupling member 40B by ultrasonic welding (see FIG. 1).

The second current collector 100B is made of a metal film, for example. The second current collector 100B is made of metal containing copper, for example. As a result, the second current collector 100B may be suitably used as a negative electrode current collector. When the first current collector 100A is a negative electrode current collector and the second current collector 100B is a positive electrode current collector, the second current collector 100B may be made of metal containing aluminum. The second current collector 100B may include a configuration similar to that of the first current collector 100A.

The second active material layers 200B are laminated on both surfaces of the second current collector 100B. In the present embodiment, the second electrode 11B is a negative electrode. Therefore, the second active material layers 200B are negative electrode active material layers. The second active material layers 200B may be positive electrode active material layers.

As described above, the first current collector 100A according to one embodiment of the present disclosure includes the support layer 110, the first electrically conductive layer 120, and the first intermediate electrically conductive layer 130. The support layer 110 is made of a resin composition having an electrical insulation property. The first electrically conductive layer 120 is made of metal containing aluminum. The first intermediate electrically conductive layer 130 is made of metal containing magnesium. The first electrically conductive layer 120 is joined to the support layer 110 via the first intermediate electrically conductive layer 130.

With the configuration described above, it is possible to improve the strength of the electrically conductive layer as a whole by the first intermediate electrically conductive layer 130 containing magnesium while causing the surface of the first current collector 100A to be aluminum from the viewpoint of providing the first active material layer 200A on the first electrically conductive layer 120. Therefore, it is possible to inhibit the first electrically conductive layer 120 from being peeled off from the support layer 110.

The first current collector 100A further includes the tab portion 160. The support layer 110 includes the main body portion 111 and the extending portion 112. The main body portion 111 is joined to the first intermediate electrically conductive layer 130. The extending portion 112 extends from the main body portion 111. The first electrically conductive layer 120 includes the first electrically conductive main body portion 121 and the first electrically conductive extending portion 122. The first electrically conductive main body portion 121 is joined to the first intermediate electrically conductive layer 130. The first electrically conductive extending portion 122 extends from the first electrically conductive main body portion 121 and is joined to the extending portion 112. The tab portion 160 is joined to the first electrically conductive extending portion 122 by ultrasonic welding.

With the configuration described above, it is possible to reduce the number of interfaces between layers in the direction in which the tab portion 160 and the first electrically conductive extending portion 122 are lined up. Therefore, it is possible to improve the mechanical joining strength in the ultrasonic welding between the tab portion 160 and the first electrically conductive extending portion 122.

The tab portion 160 is joined to the first electrically conductive main body portion 121 by ultrasonic welding. As a result, by the tab portion 160, it is possible to mechanically inhibit the connecting part between the first electrically conductive main body portion 121 and the first electrically conductive extending portion 122 from being spaced apart from the end portion of the first intermediate electrically conductive layer 130.

In the present embodiment, the first active material layer 200A is laminated on the first electrically conductive main body portion 121. As a result, the first active material layer 200A is laminated on the first electrically conductive main body portion 121 laminated on the first intermediate electrically conductive layer 130, and hence it is possible to inhibit the first active material layer 200A from being peeled off from the support layer 110 with the first electrically conductive layer 120.

In the present embodiment, the first active material layer 200A is spaced apart from the tab portion 160. Here, the tab portion 160 is also joined to the first electrically conductive main body portion 121. Therefore, the current path from the first active material layer 200A to the tab portion 160 or the current path from the tab portion 160 to the first active material layer 200A is formed by not only the first electrically conductive main body portion 121 but also by the first intermediate electrically conductive layer 130. As a result, it is possible to reduce the electrical resistance of the current path from the first active material layer 200A to the tab portion 160 or the current path from the tab portion 160 to the first active material layer 200A.

In the description of the embodiment described above, combinable configurations may be combined with each other.

It is to be understood that the embodiments disclosed above are merely examples in all aspects and in no way intended to limit the disclosure. The scope of the present disclosure is defined by the scope of the claims and not by the description above. All modifications made within the scope and spirit equivalent to those of the claims are intended to be included in the disclosure.

What is claimed is:

1. A current collector, comprising:
a support layer;
an electrically conductive layer; and
an intermediate electrically conductive layer, wherein:
the support layer is made of a resin composition having an electrical insulation property;
the electrically conductive layer is made of metal containing aluminum;
the intermediate electrically conductive layer is made of metal containing magnesium; and
the electrically conductive layer is joined to the support layer via the intermediate electrically conductive layer.

2. The current collector according to claim 1, further comprising a tab portion, wherein:
the support layer includes a main body portion and an extending portion;
the main body portion is joined to the intermediate electrically conductive layer;
the extending portion extends from the main body portion;
the electrically conductive layer includes an electrically conductive main body portion and an electrically conductive extending portion;
the electrically conductive main body portion is joined to the intermediate electrically conductive layer;
the electrically conductive extending portion extends from the electrically conductive main body portion and is joined to the extending portion; and
the tab portion is joined to the electrically conductive extending portion by ultrasonic welding.

3. The current collector according to claim 2, wherein the tab portion is joined to the electrically conductive main body portion by ultrasonic welding.

4. A battery, comprising:
an electrode body; and
an external terminal, wherein:
the electrode body includes a first electrode, a second electrode, and a separator;
the first electrode includes a current collector and an active material layer;
the current collector includes a support layer, an electrically conductive layer, and
an intermediate electrically conductive layer;
the support layer is made of a resin composition having an electrical insulation property;
the electrically conductive layer is made of metal containing aluminum;
the intermediate electrically conductive layer is made of metal containing magnesium;
the electrically conductive layer is joined to the support layer via the intermediate electrically conductive layer;
the active material layer is laminated on the electrically conductive layer;
the separator is laminated on the active material layer;
the second electrode is laminated on the active material layer via the separator; and
the external terminal is electrically connected to the electrically conductive layer.

5. The battery according to claim 4, wherein:
the current collector further includes a tab portion;
the support layer includes a main body portion and an extending portion;
the main body portion is joined to the intermediate electrically conductive layer;
the extending portion extends from the main body portion;
the electrically conductive layer includes an electrically conductive main body portion and an electrically conductive extending portion;
the electrically conductive main body portion is joined to the intermediate electrically conductive layer;
the electrically conductive extending portion extends from the electrically conductive main body portion and is joined to the extending portion;
the tab portion is joined to the electrically conductive extending portion by ultrasonic welding;
the tab portion is joined to the electrically conductive main body portion by ultrasonic welding;
the active material layer is laminated on the electrically conductive main body portion;
the active material layer is spaced apart from the tab portion; and
the external terminal is electrically connected to the tab portion.
